(19) United States
(12) Patent Application Publication
(10) Pub. No.: US 2026/0270765 A1
(43) Pub. Date: Sep. 10, 2026

(54) User equipment and methods for communication between the user equipment and a network entity using a QUIC protocol

(71) Applicant: MEDIATEK INC., Hsin-Chu (TW)

(72) Inventors: Yu-Hsin Lin, Hsinchu City (TW); Tze Jie Tan, Hsinchu City (TW); Chia-Lin Lai, Hsinchu City (TW); Yuan-Chieh Lin, Hsinchu City (TW)

(73) Assignee: MEDIATEK INC., Hsin-Chu (TW)

(21) Appl. No.: 19/166,868

(22) PCT Filed: May 17, 2024
(86) PCT No.: PCT/CN2024/093863

§ 371 Date: Sep. 18, 2025

Related U.S. Application Data
(60) Provisional application No. 63/503,176, filed on May 19, 2023.

(51) Int. Cl. H04W 28/02; H04W 76/15; H04W 80/10

(52) U.S. Cl. CPC H04W 28/0268; H04W 76/15; H04W 80/10

(57) ABSTRACT

A user equipment (UE) has a radio frequency (RF) transceiver and a processor coupled to the RF transceiver. The processor controls the RF transceiver to initiate establishment of a QUIC (Quick User Datagram Protocol Internet Connection) connection for each quality of service (QOS) flow of a multi-access (MA) protocol data unit (PDU) session. During the establishment of the QUIC connection, the processor controls the RF transceiver to send a QUIC packet to the network entity via a QoS flow of the MA PDU session associated with the QUIC connection. After the establishment of the QUIC connection is completed, the processor controls the RF transceiver to send all uplink traffic of the QUIC connection to the QoS flow associated with the QUIC connection.

### CROSS REFERENCE TO RELATED APPLICATION

This application claims the benefit of U.S. Provisional Application No. 63/503,176, filed on May 19, 2023. The content of the application is incorporated herein by reference.

### TECHNICAL FIELD

The disclosed embodiments relate generally to wireless communication, and, more particularly, to apparatus and methods for communication between a user equipment (UE) and a network entity using a QUIC (Quick User Datagram Protocol Internet Connection) protocol.

### BACKGROUND

Access Traffic Steering, Switching and Splitting (ATSSS) is a feature being standardized as part of the 3rd Generation Partnership Project (3GPP) Release 16 for 5th generation wireless systems (5G). It enhances network performance and user experience by enabling seamless and optimized data transmission across multiple access networks.

Multi-Path QUIC (MPQUIC) is an extension of QUIC (Quick User Datagram Protocol (UDP) Internet Connection) protocol specifically designed to leverage the benefits of ATSSS in 5G networks. It enables the establishment of multiple QUIC connections between the User Equipment (UE) and the network, allowing for the efficient distribution of traffic across multiple access paths.

A device could use MPQUIC to simultaneously send data over both a 3GPP access network (such as 5G NR) and a non-3GPP access network (such as Wi-Fi), effectively increasing the total available bandwidth. This can improve the performance and reliability of data transmission, especially in environments where one or both of the networks may be congested or unreliable.

Although MPQUIC (Multi-Path QUIC) is a protocol with significant potential to enhance the performance of both 3GPP and non-3GPP access networks, MPQUIC is still under development.

### SUMMARY

In an embodiment of the present disclosure, a method for communication with a network entity is disclosed. The method comprises initiating, by a user equipment (UE), establishment of a QUIC (Quick User Datagram Protocol Internet Connection) connection for each quality of service (QOS) flow of a multi-access (MA) protocol data unit (PDU) session established between the network entity and the UE; sending, by the UE, a QUIC packet to the network entity via a QoS flow of the MA PDU session associated with the QUIC connection during the establishment of the QUIC connection; and sending, by the UE, all uplink traffic of the QUIC connection to the QoS flow associated with the QUIC connection after the establishment of the QUIC connection is completed.

In another embodiment of the present disclosure, a method for communication with a user equipment (UE) is disclosed. The method comprises receiving, by a first network entity, a session establishment request or a session modification request from a second network entity indicating information of a quality of service (QOS) flow of a multi-access (MA) protocol data unit (PDU) session; receiving, by the first network entity, a QUIC packet from the UE via the QoS flow of the MAPDU session; and determining, by the first network entity, association between the QUIC connection and the QoS flow of the MA PDU session associated with the QUIC connection according to the QUIC packet.

In another embodiment of the present disclosure, a user equipment (UE) is disclosed. The UE comprises a radio frequency (RF) transceiver and a processor. The RF transceiver is configured to receive data from the network entity and transmit data to the network entity. The processor is coupled to the RF transceiver and configured to control the RF transceiver to initiate establishment of a QUIC (Quick User Datagram Protocol Internet Connection) connection for each quality of service (QOS) flow of a multi-access (MA) protocol data unit (PDU) session established between the network entity and the UE; to send a QUIC packet to the network entity via a QoS flow of the MA PDU session associated with the QUIC connection during establishment of the QUIC connection; and to send all uplink traffic of the QUIC connection to the QoS flow associated with the QUIC connection after the establishment of the QUIC connection is completed.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a 5G network supporting MPQUIC according to an embodiment of the present disclosure.

FIG. 2 illustrates a simplified block diagram of a UE and a network entity according to an embodiment of the disclosure.

FIG. 3 shows a process for communication between the network entity and the UE through the QUIC protocol according to an embodiment of the disclosure.

### DETAILED DESCRIPTION

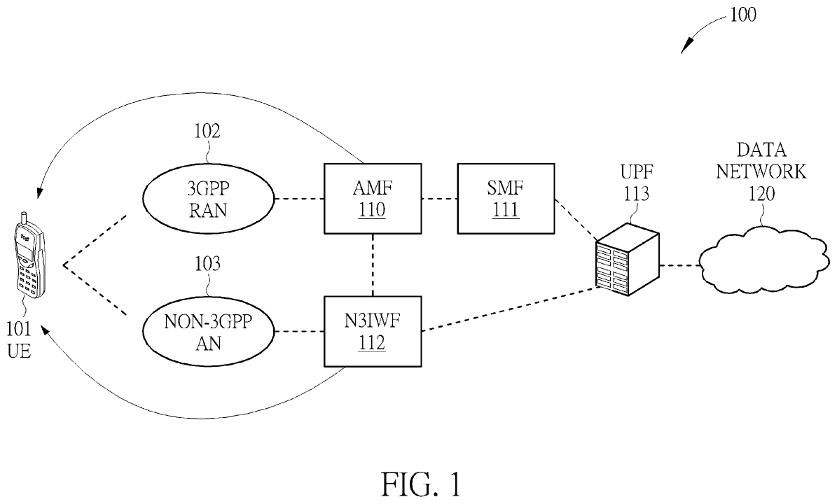

FIG. 1 illustrates a 5th generation (5G) network 100 supporting Multi-Path QUIC (MPQUIC) according to an embodiment of the present disclosure. The 5G network 100 is a wireless network that provides high-speed, low-latency data transmission. The 5G network 100 comprises a user equipment (UE) 101, a 3GPP radio (e.g., NR) access network (RAN) 102, a non-3GPP access network (AN) 103, an Access and Mobility Management Function (AMF) 110, a Session Management Function (SMF) 111, a Non-3GPP Interworking Function (N3IWF) 112, a User Plane Function (UPF) 113, and a data network 120. The AMF 110 communicates with the base station, the SMF 111 and the UPF 113 for access and mobility management of wireless access devices in the 5G network 100. The SMF 111 is primarily responsible for interacting with the decoupled data plane, creating, updating and removing Protocol Data Unit (PDU) sessions and managing session context with the UPF 113. The N3IWF 112 functionality interfaces to 5G core network control plane functions, responsible for routing messages outside 5G RAN. The UE 101 may be a smart phone, a wearable device, an Internet of Things (IOT) device, a tablet, etc.

In an Access Stratum (AS) layer, a radio access network (RAN) provides radio access for the UE 101 via a radio access technology (RAT). In a Non-Access Stratum (NAS) layer, the AMF 110 and the SMF 111 communicate with the RAN and a fifth generation core (5GC) for access and mobility management and PDU session management of wireless access devices in the 5G network 100. The 3GPP RAN 102 may include base stations (gNBs) providing radio access for the UE 101 via various 3GPP RATs including 5G, 4G, and 3G/2G. The non-3GPP AN 103 may include access points (APs) providing radio access for the UE 101 via non-3GPP RATs including WiFi. On one hand, the UE 101 can obtain access to the data network 120 through the 3GPP RAN 102, the AMF 110, the SMF 111, and the UPF 113. On the other hand, the UE 101 also can obtain access to the data network 120 through the non-3GPP AN 103, the N3IWF 112, the AMF 110, the SMF 111, and the UPF 113. The UE 101 may be equipped with a single radio frequency (RF) module or transceiver or multiple RF modules or transceivers for services via different access networks (ANs) and/or core networks (CNs).

In the realm of 5th generation wireless systems (5G) technology, PDU (Protocol Data Unit) sessions play a crucial role in enabling seamless data transmission between user devices and networks, such as the internet. These PDU sessions act as dedicated pathways, ensuring the efficient and reliable delivery of application data packet. Each PDU session is identified by a PDU session ID (PSI), and may include multiple quality of service (QOS) flows and QoS rules.

Each PDU session can be established over a 3GPP RAN, or over a non-3GPP AN for radio access. 5G Session management (5GSM) for PDU sessions over both the 3GPP RAN 102 and the non-3GPP AN 103 are managed by the AMF 110 and the SMF 111 via non-access stratum (NAS) signaling. In the 5G network 100, the UE 101 can be simultaneously connected to both the 3GPP RAN 102 and the non-3GPP AN 103 (using 3GPP NAS signaling), thus the 5G network 100 is able to take advantage of these multiple accesses to improve the user experience, optimizing the traffic distribution across various accesses. The 3rd generation partnership project (3GPP) has introduced Multi-Access (MA) PDU session in the fifth generation system (5GS). An MA PDU session uses one 3GPP access network or one non-3GPP access network at a time, or simultaneously one 3GPP access network and one non-3GPP access network. In addition, the UE 101 and the network can support Access Traffic Steering Switching and Splitting (ATSSS) functionalities to distribute traffic over 3GPP access and non-3GPP access for the established MA PDU session.

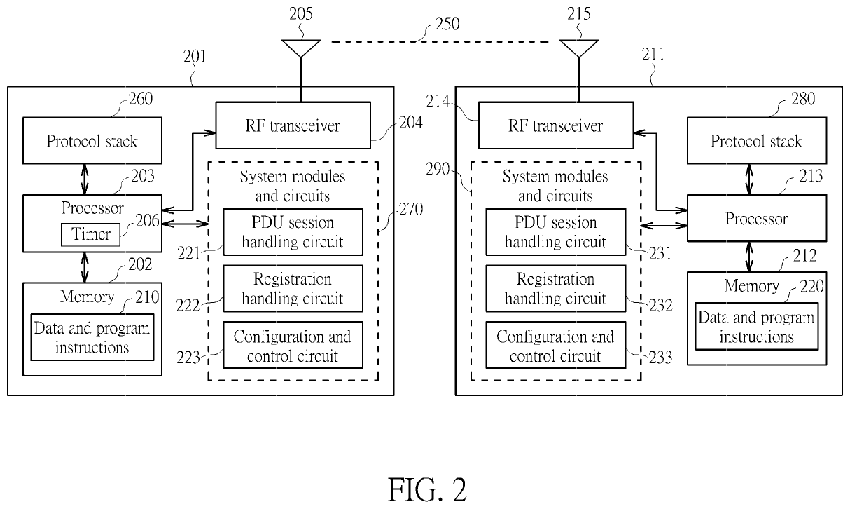

FIG. 2 illustrates a simplified block diagram of wireless devices, e.g., a UE 201 and a network entity 211 according to an embodiment of the disclosure. The network entity 211 may be a base station, the UPF 113, the AMF 110, or the SMF 111. The network entity 211 has an antenna 215, which transmits and receives radio signals. A radio frequency (RF) transceiver 214, coupled with the antenna 215, receives RF signals from the antenna 215, converts them to baseband signals and sends them to the processor 213. The RF transceiver 214 also converts baseband signals received from the processor 213 to RF signals, and sends them out to the antenna 215. The processor 213 processes the received baseband signals and invokes different functional modules to perform features in the network entity 211. The memory 212 stores data and program instructions 220 to control the operations of the network entity 211. The network entity 211 also includes a protocol stack 280 and a set of system modules and circuits 290. The set of system modules and circuits 290 comprises a PDU session handling circuit 231 that performs PDU session establishment and modification procedures with the UE 201, a registration handling circuit 232 that performs registration with the UE 201 via 3GPP or non-3GPP access, and a configuration and control circuit 233 that handles configuration and control parameters for mobility management and session management.

Similarly, the UE 201 has a memory 202, a processor 203, and an RF transceiver 204. The RF transceiver 204 is coupled with an antenna 205, receives RF signals from the antenna 205, converts them to baseband signals, and sends them to the processor 203. The RF transceiver 204 also converts baseband signals received from the processor 203 to RF signals, and sends them out to the antenna 205. The processor 203 processes the received baseband signals and invokes different functional modules and circuits to perform features in the UE 201. The processor 203 may comprise a timer 206 to count a time duration when the UE 201 establishes a QUIC connection associated with a QoS flow of a Multi-Access (MA) PDU session 250. The MA PDU session 250 is established by the network entity 211, and each QoS flow of the MA PDU session 250 is established during a PDU session establishment procedure or a PDU session modification procedure. The memory 202 stores data and program instructions 210 to be executed by the processor 203 to control the operations of the UE 201.

The UE 201 also comprises a protocol stack 260 and a set of system modules and circuits 270 to carry out functional tasks of the UE 201. The set of system modules and circuits 270 includes a PDU session handling circuit 221 that performs PDU session establishment and modification procedures with the network entity 211, a registration handling circuit 222 that performs registration with the network entity 211 via 3GPP or non-3GPP access, and a configuration and control circuit 223 that handles configuration and control parameters for mobility management and session management.

Each of the protocol stacks 260 and 280 comprises a NAS layer to communicate with an AMF/SMF/MME entity connecting to the core network, a Radio Resource Control (RRC) layer for high layer configuration and control, a Packet Data Convergence Protocol/Radio Link Control (PDCP/RLC) layer, a Media Access Control (MAC) layer, and a Physical (PHY) layer. Each of the sets of system modules and circuits 270 and 290 may be implemented and configured by software, firmware, hardware, and/or combination thereof.

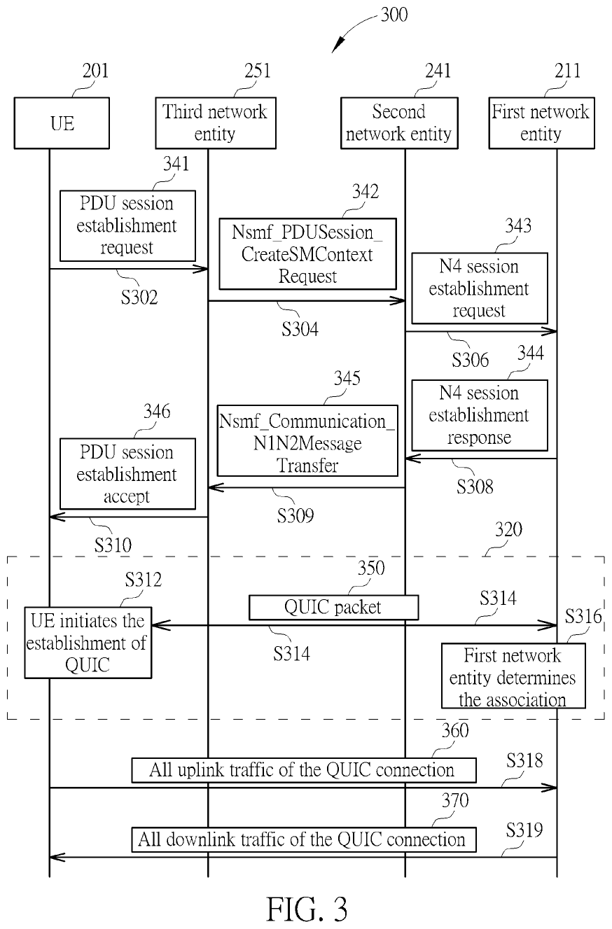

FIG. 3 shows a process 300 for communication between the network entity 211 (i.e., a first network entity) and the UE 201 through the QUIC (Quick User Datagram Protocol Internet Connection) protocol according to an embodiment of the disclosure. The process 300 comprises steps S302, S304, S306, S308, S309, S310, S312, S314, S316, S318, and S319. Steps S312, S314, and S316 collectively constitute a process 320 for establishing a QUIC connection for each QoS flow of the MA PDU session 250.

At step S302, the UE 201 sends a PDU session establishment request message 341 to a third network entity 251 (e.g., the AMF 110 in FIG. 1). At step S304, the third network entity 251 sends a Nsmf_PDUSession_CreateSMContext Request message 342 to a second network entity 241 (e.g., the SMF 111 in FIG. 1). At step S306, the second network entity 241 sends a N4 session establishment request 343 which contains the information of the QoS flow of the MA PDU session 250 to the first network entity 211 (e.g., the UPF 113 in FIG. 1). At step S308, the first network entity 211 acknowledges the N4 session establishment request 343 by responding with an N4 session establishment response 344. In another embodiment, the N4 session establishment request 343 can be replaced with an N4 session modification request, and the N4 session establishment response 344 can be replaced with an N4 session modification response. At step S309, the second network entity 241 sends a Namf_Communication_NIN2MessageTransfer message 345 which contains a PDU session establishment accept message 346 for the establishment of the MA PDU session 250. At step S310, the third network entity 251 sends the PDU session establishment accept message 346 to establish the MA PDU session 250. The MA PDU session 250 can include one or more QoS flows. The QoS flows serve as the most granular level of QoS differentiation within the MA PDU session 250, and enable the network to apply distinct QoS treatments to different traffic streams based on specific requirements. Each QoS flow is identified by a unique QoS Flow Identifier (QFI), allowing the network to prioritize, schedule, and handle traffic accordingly. In addition, the QoS flows can use the Multi-Path QUIC (MPQUIC) functionality. In other words, each of the QoS flows of the MA PDU session 250 may follow the MPQUIC protocol. By employing MPQUIC, each QoS flow can benefit from improved link utilization across multiple access paths. This means that the network can effectively distribute traffic load, alleviating congestion on individual paths and maximizing the utilization of available network resources. Consequently, MPQUIC contributes to reduced latency for latency-sensitive applications, such as real-time video calls and online gaming, ensuring a smoother and more responsive user experience.

At step S312, the UE 201 initiates the establishment of a QUIC connection for each QoS flow of the MA PDU session 250 when the QoS flow(s) of the MA PDU session 250 is/are created. If the MA PDU session 250 has a single QoS flow, the UE 201 initiates the establishment of a single QUIC connection for the single QoS flow. If the MA PDU session 250 has a plurality of QoS flows, the UE 201 initiates the establishment of a plurality of QUIC connections for the plurality of QoS flows. In detail, the UE 201 intelligently determines the number of QUIC connections to establish based on the MA PDU session 250. By establishing the QUIC connection(s), the MPQUIC functionality could be used for the QoS flow(s) of the MA PDU session 250.

Step S314 occurs within the process 320 and focuses on the handshake between the UE 201 and the first network entity 211. At step S314, the processor 203 of the UE 201 controls the RF transceiver 204 to send a QUIC packet 350 to the first network entity 211 via a QoS flow of the MA PDU session 250 associated with a QUIC connection to be established. The QUIC packet 350 traverses a designated QoS flow within the MA PDU session associated with the QUIC connection to be established. The QUIC packet 350 can take various forms, including an initial packet, a keep-alive packet, a heartbeat packet, or a liveness testing packet. The initial packet uses long headers with a type value of 0x00. The initial packet may carry the first CRYPTO frames for key exchange, and may carry ACK frames. A keep-alive packet serves as a crucial mechanism for maintaining the continuity of data connections in 5G networks, adhering to 3GPP specifications. A keep-alive packet typically contains minimal information, such as sequence numbers or timestamps, to minimize overhead and conserve network resources. A heartbeat packet extends the concept of connection monitoring beyond a single entity. In 5G networks, both the User Equipment (UE) and the network entity can exchange heartbeat packets to verify the liveness of the connection and detect potential connection failures. Heartbeat packets typically carry timestamps or sequence numbers that allow each party to assess the responsiveness of the other. A liveness testing packet takes the proactive approach of explicitly testing the liveness of a connection. Liveness testing packets are sent specifically to verify the connection's status when there are concerns about its health. Liveness testing packets may carry additional information or follow a different protocol to elicit a response from the receiver.

In an embodiment of the present disclosure, when the processor 203 of the UE 201 controls the RF transceiver 204 to initiate the establishment of the QUIC connection, the processor 203 controls the RF transceiver 204 to send the QUIC packet 350 to the first network entity 211 immediately. In another embodiment of the present disclosure, when the processor 203 controls the RF transceiver 204 to initiate the establishment of the QUIC connection, the processor 203 activates the timer 206 to count a time duration. Then, the processor 203 does not control the RF transceiver 204 to send the QUIC packet 350 to the first network entity 211 until the time duration counted by the timer 206 exceeds a predetermined length.

At step S316, the first network entity 211 leverages the information gleaned from the received QUIC packet 350, and the first network entity 211 determines the association between each QUIC connection and the QoS flow of the MA PDU session 250 associated with this QUIC connection according to the received QUIC packet 350. The received QUIC packet 350 is a handshake packet, so the first network entity 211 can determine the association between each QUIC connection and the corresponding QoS flow according to the QUIC packet 350. Since step S316 is performed during the process 320 for establishing the QUIC connection, the first network entity 211 can determine the association as early as when the UE 201 is establishing the QUIC connection(s), rather than waiting for the QUIC connection(s) to be fully established.

Steps S318 and S319 are performed after the QUIC connection for each QoS flow of the MA PDU session 250 is established at steps S312, S314 and S316. At step 318, the processor 203 of the UE 201 controls the RF transceiver 204 to send all uplink traffic 360 of the QUIC connection(s) established at steps S312, S314 and S316 to the QoS flow associated with the QUIC connection(s) established at steps S312, S314 and S316. At step 319, the processor 213 of the first network entity 211 controls the RF transceiver 214 to send all downlink traffic 370 of the QUIC connection(s) established at steps S312, S314 and S316 to the QoS flow associated with the QUIC connection(s) established at steps S312, S314 and S316. The association determined by the first network entity 211 at step S316 ensures that the first network entity 211, at step S319, can accurately send the downlink data (e.g., all downlink traffic 370 of the QUIC connection(s) established at steps S312, S314 and S316) to the corresponding QoS flow(s), enabling the first network entity 211 to utilize the multipath functionality of QUIC, MPQUIC.

In conclusion, the disclosure presents a user equipment (UE) and a method for communication between the UE and a network entity using the QUIC protocol. The UE initiates QUIC connection(s) for each QoS flow within the established MA PDU session. During the establishment of the QUIC connection(s), the UE sends a QUIC packet to the network entity for handshake purposes. By analyzing the received QUIC packet, the network entity can determine the association between each QUIC connection and a corresponding QoS flow as early as when the UE is establishing the QUIC connection(s). After the QUIC connection for each QoS flow of the MA PDU session is established, the UE sends all uplink traffic of the QUIC connection(s) of the associated QoS flow to the network entity to ensure the network can determine the association of the QUIC connection and the QoS flow, and further utilizes MPQUIC and sends all downlink traffic of the QUIC connection(s) of the associated QoS flow to the UE.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for communication with a network entity, comprising:
initiating, by a user equipment (UE), establishment of a QUIC (Quick User Datagram Protocol Internet Connection) connection for each quality of service (QOS) flow of a multi-access (MA) protocol data unit (PDU) session established between the network entity and the UE;
sending, by the UE, a QUIC packet to the network entity via a QoS flow of the MAPDU session associated with the QUIC connection during the establishment of the QUIC connection;
sending, by the UE, all uplink traffic of the QUIC connection to the QoS flow associated with the QUIC connection after the establishment of the QUIC connection is completed.

2. The method of claim 1, wherein the UE initiates the establishment of the QUIC connection when the QoS flow is established.

3. The method of claim 1, wherein when the UE initiates the establishment of the QUIC connection, the UE immediately sends the QUIC packet to the network entity.

4. The method of claim 1, further comprising:
activating a timer to count a time duration when the UE initiates the establishment of the QUIC connection;
wherein the UE does not send the QUIC packet to the network entity until the time duration counted by the timer exceeds a predetermined length.

5. The method of claim 1, wherein the QUIC packet is an initial packet, a keep-alive packet, a heartbeat packet, or a liveness testing packet.

6. The method of claim 1, wherein the QoS flow of the MA PDU session associated with the QUIC connection follows a Multi-Path QUIC (MPQUIC) protocol.

7. A method for communication with a user equipment (UE), comprising:
receiving, by a first network entity, a session establishment request or a session modification request from a second network entity indicating information of a quality of service (QOS) flow of a multi-access (MA) protocol data unit (PDU) session;
receiving, by the first network entity, a QUIC packet from the UE via the QoS flow of the MA PDU session; and
determining, by the first network entity, association between the QUIC connection and the QoS flow of the MA PDU session associated with the QUIC connection according to the QUIC packet.

8. The method of claim 7, wherein the session establishment request or the session modification request is an N4 session establishment request or an N4 session modification request.

9. The method of claim 7, wherein the QoS flow is established during a PDU session establishment procedure or a PDU session modification procedure.

10. The method of claim 7, wherein the QUIC packet is received during the establishment of the QUIC connection.

11. The method of claim 7, wherein the QUIC packet is an initial packet, a keep-alive packet, a heartbeat packet, or a liveness testing packet.

12. The method of claim 7, wherein the QoS flow of the MA PDU session associated with the QUIC connection follows a Multi-Path QUIC (MPQUIC) protocol.

13. The method of claim 7, further comprising
sending, by first the network entity, all downlink traffic of the QUIC connection to the QoS flow associated with the QUIC connection after the establishment of the QUIC connection is completed.

14. A user equipment (UE), comprising:
a radio frequency (RF) transceiver configured to receive data from a network entity and transmit data to the network entity; and
a processor coupled to the RF transceiver and configured to:
control the RF transceiver to initiate establishment of a QUIC (Quick User Datagram Protocol Internet Connection) connection for each quality of service (QOS) flow of a multi-access (MA) protocol data unit (PDU) session established between the network entity and the UE;
control the RF transceiver to send a QUIC packet to the network entity via a QoS flow of the MA PDU session associated with the QUIC connection during establishment of the QUIC connection; and
control the RF transceiver to send all uplink traffic of the QUIC connection to the QOS flow associated with the QUIC connection after the establishment of the QUIC connection is completed.

15. The UE of claim 14, wherein when the establishment of the QUIC connection is initiated, the RF transceiver immediately sends all uplink traffic of the QUIC connection to the network entity.

16. The UE of claim 14, wherein the processor comprises a timer configured to count a time duration when the establishment of the QUIC connection is initiated; and
wherein the processor does not control the RF transceiver to send the QUIC packet to the network entity until the time duration counted by the timer exceeds a predetermined length.

17. The UE of claim 14, wherein the QUIC packet is an initial packet, a keep-alive packet, a heartbeat packet, or a liveness testing packet.

18. The UE of claim 14, wherein the QoS flow of the MA PDU session associated with the QUIC connection follows a Multi-Path QUIC (MPQUIC) protocol.

19. The UE of claim 14, wherein the network entity determines association between the QUIC connection and the QoS flow of the MA PDU session associated with the QUIC connection according to the QUIC packet.
